(19) United States
(12) Patent Application Publication
(10) Pub. No.: US 2010/0258362 A1
(43) Pub. Date: Oct. 14, 2010

(54) ACTUATOR POWERED DEFORMABLE SOFT-BODIED AUTONOMOUS PLATFORMS

(76) Inventor: Barry Trimmer, Medford, MA (US)

Correspondence Address: CHOATE, HALL & STEWART LLP, TWO INTERNATIONAL PLACE, BOSTON, MA, 02110, US

(21) Appl. No.: 12/747,839

(22) PCT Filed: Dec. 15, 2008
(86) PCT No.: PCT/US08/86891

§ 371 Date: Jun. 11, 2010

Related U.S. Application Data
(60) Provisional application No. 61/013,828, filed on Dec. 14, 2007.

(51) Int. Cl. B25J 11/00; G06F 19/00

(52) U.S. Cl. 180/7.1; 700/245; 901/1

(57) ABSTRACT

The present solution described herein provides apparatuses, methods and systems for coordinating and controlling movement of soft-bodied robots, or soft-bodied platforms. A soft-bodied robot may move across a terrain by morphing, deforming, expanding, shrinking, extending, contracting, twisting, untwisting, bending or straightening of its body using actuators positioned within the body. The body may be divided into many segments. The segments may be moved or controlled by actuators that are attached to various sections of the body. The actuators may deform or reshape themselves to induce movement onto the soft-bodied robot whose soft material body walls allow for morphing and deformation. The soft-bodied robot may further include systems and apparatuses for controlling and coordinating the movement of the robots and performing any additional functionality.

### RELATED APPLICATIONS

The present application claims priority to U.S. Provisional Application No. 61/013,828 filed on Dec. 14, 2007, which is herein entirely incorporated by reference.

### FIELD OF THE INVENTION

The present disclosure is generally related to the field of soft-bodied robots or soft-bodied mobile platforms. More specifically, the present application is directed to soft-bodied robots capable of movement by morphing or deformation. The present disclosure is also directed to systems and methods for actuator powered movement of soft-bodied robots.

### BACKGROUND

Autonomous platforms, such as robots, are widely used in many environments and for variety of applications. Depending on their design, autonomous platforms may be utilized for tasks relating to manufacturing and streamlining of manufacturing processes, precise component handling, and movement across various terrains and surfaces. However, in spite of such a variety of applications, previous designs of robots commonly include only sturdy and rigid components. Such components inherently limit the range and type of the movement provided by autonomous platforms. In addition, rigid components further disable the platforms to deform or reshape their bodies, thus further limiting their functionality and even the terrain over which these platforms can move. Given these limitations, autonomous platforms that have sturdy and inflexible components are often designed for only specific purposes, specific tasks and for movement in specific environments. Hence, a demand exists for autonomous platforms capable of deforming and reshaping their bodies in order to provide movement across a variety of terrains and environments.

### SUMMARY

The present disclosure described herein is related to platforms comprising soft materials that enable morphing or deforming of the soft-bodied platforms and movement of soft-bodied platforms in three degrees of freedom. The solution presented herein relates to soft-bodied platforms, herein also referred to as soft-bodied robots, that may move across a terrain by morphing, deforming, expanding, shrinking, extending, contracting, twisting, untwisting, bending or straightening their bodies. In addition, the solution presented is related to systems and methods for controlling the movement of soft-bodied robots by utilizing actuators positioned within the bodies of the soft-bodied robots in order to control and manage their movement.

In some aspects, the present disclosure is related to a soft-bodied autonomous platform comprising a body. The body may further comprise a first segment, a second segment and a third segment. The second segment may be connected with the first segment and the third segment, while the first and third segments are not connected to each other. The body may also comprise a first actuator attached to an interior of the first segment and an interior of the second segment. The first actuator may be enclosed within the body. The body may also comprise a second actuator attached to the interior of the first segment and to an interior of the third segment. The second actuator may be enclosed within the body. In some embodiments, the first actuator deforms the first segment and the second segment. In many embodiments, the second actuator deforms the first, second and third segments.

In some embodiments, the body comprises a third actuator attached to the interior of the second segment and the interior of the third segment. The third actuator may be enclosed within the body. The third actuator may deform the second and the third segments. In some embodiments, the body comprises a fourth segment connected with the third segment, the fourth segment not connected with the first and second segments. In other embodiments, the body comprises a third actuator having a first and a second end, the first end of the third actuator attached to the interior of the first segment and the second end of the third actuator attached to an interior of the fourth segment. The third actuator may be enclosed within the body and may deform the first, the second, the third and the fourth segments. In many embodiments, the body further comprises a fourth actuator having a first end and a second end. The first end of a fourth actuator may attach to the interior of the fourth segment with both ends of the fourth actuator, thus deforming the fourth segment. In further embodiments, the fourth actuator attaches to the interior of the third segment and the interior of the fourth segment. The fourth actuator may be enclosed within the body and may deform the third and the fourth segments.

Sometimes, any actuator, or any group of actuators, deform a segment or a plurality of segments of the body by contracting or extending any one or all of the segments comprising the body. In some embodiments, any actuator, or any group of actuators, deform a segment or a plurality of segments by bending or straightening any one of, or all of the segments. Sometimes, any one of, or any group of actuators deform a segment, or a plurality of segments by twisting or untwisting any or all of the segments comprising the body. In some embodiments, any actuator, or any group of actuators deform a segment or a plurality of segments by expanding or shrinking any or all of the segments comprising the body.

In some embodiments, the body comprises an elastomeric material. Sometimes, any one of the actuators comprises a shaped memory alloy. In other embodiments, any one of the actuators comprises an elastomeric material. In yet other embodiments, any actuator comprises an electroactive polymer. In some embodiments, any actuator or any plurality of the actuators, produce a crawling movement of the body. In some embodiments, any one of the actuators or any plurality of the actuators produce a cantilevering movement of the body. In other embodiments, any one of the actuators or any plurality of the actuators produce a twisting or a turning movement of the body. In further embodiments, any one of the actuators or any plurality of the actuators produce a bending or straightening movement of the body. In yet further embodiments, any one of the actuators or any plurality of the actuators produce a contracting or an extending movement of the body.

Sometimes, the body may further comprise a pressure controlling system controlling the pressure inside a portion of the body or inside the whole body. In some embodiments, the body further comprises a sensor. In other embodiments, the body further comprises a detector. Sometimes, the body comprises a transmitter or a receiver, transmitting or receiving a signal. Sometimes, the body comprises a power supply or a battery. In some embodiments, the body comprises an electric or electronic circuitry or hardware. Sometimes, the body comprises a software stored on a memory inside the body. In some embodiments, the body comprises a hardware or a device processing information, data or commands, such as a microprocessor. In other embodiments, the body comprises a control circuit or a controller.

In some embodiments, the body of the autonomous platform is shaped substantially similarly to a body of a caterpillar. In some embodiments, the body further comprises a set of legs. Sometimes a leg or a set of legs may comprise a bump or a set of bumps protruding from a bottom portion of the body. In some embodiments, a leg or a set of legs comprises a sharp tip or a plurality of sharp tips. In other embodiments, a leg or a set of legs comprises a hook or a crochet or a plurality of hooks or crochets. In further embodiments, the body comprises a terminal leg or a plurality of terminal legs. A terminal leg may comprise a bump protruding from a bottom abdominal portion of a segment located on an end or near an end of the body. In yet further embodiments, the body comprises a portion of the body defining a groove or a plurality of grooves.

In some aspects, the present disclosure is related to a deformable autonomous apparatus capable of crawling. The apparatus may comprise a body comprising a plurality of deformable concatenated segments wherein deformation of a first one of a plurality of segments causes deformation in a second one of the plurality of segments. In some embodiments, deformation of the second one of a plurality of segments causes deformation in the first one of the plurality of segments and a third one of the plurality of segments. Sometimes, the deformation is one of a contraction or an extension. In some embodiments, the deformation of the first segment or the second segment produces a change in volume of the deformed segment. In other embodiments, any one of the segments or any plurality of the segments further comprise an actuator comprising a shaped memory alloy enclosed within the apparatus. Sometimes, the apparatus comprises an actuator enclosed within the body. The actuator may comprise an elastomeric material or an electroactive material.

In some embodiments, the apparatus is capable of movement by cantilevering. In other embodiments, the apparatus is capable of movement by twisting or bending. In yet other embodiments, the apparatus is capable of movement by contraction or extension of at least a portion of the body. In yet other embodiments, the shape of the body is substantially similar to a shape of a caterpillar. In further embodiments, the body comprises a pressure controlling system which controls the pressure inside at least a portion of the body. In yet further embodiments, the body comprises a sensor, a detector, a camera, a microphone, a signal transmitter or a receiver, or any electronic device performing any specific task.

In some aspects, the present disclosure is related to a method for creating a movement of an autonomous apparatus. The autonomous apparatus may comprise a polymeric body having at least three concatenated segments. A second segment of the polymeric body may be connected with a first segment and a third segment, while the third segment is not connected with the first segment. The autonomous apparatus may further comprise a first actuator attached with both ends of the first actuator to an interior of the first segment. A second actuator may be attached to the interior of the first segment and an interior of a second segment. A third actuator may be attached to the interior the first segment and an interior of the third segment. The first actuator and the second actuator and the third actuator may be enclosed within the body. The first actuator may deform a first body segment and a second body segment. The second actuator may deform the first segment, the second segment, and a third body segment.

In some embodiments, a third actuator may deform a first segment. In other embodiments, a fourth actuator may deform the first segment, the second segment, the third segment and a fourth segment. The fourth actuator may be attached to the area inside of the first segment and an area inside of the fourth segment which is connected to the third segment, but not connected to the first segment and the second segment. In some embodiments, an actuator collapses any one of the first segment, the second segment or the third segment to a fraction of a maximum volume of that segment. In other embodiments, an actuator twists any one of the first segment, the second segment or the third segment. In further embodiments, an actuator bends any one of the first segment, the second segment or the third segment. In yet further embodiments, an actuator contracts any one of the first segment, the second segment or the third segment. In yet further embodiments, an actuator extends any one of the first segment, the second segment or the third segment.

In some aspects, the present disclosure is related to a method for creating a movement of an autonomous apparatus. The autonomous apparatus may comprise a body having a plurality of concatenated segments. A first segment of the plurality of concatenated segments may press against a surface. The surface may be any surface the autonomous apparatus touches or moves over. The body may deform any one of the first segment or a second segment of the plurality. The body may deform any one of the first segment or the second segment in response to the first segment pressing against the surface. The second segment may press against the surface. In some embodiments, the second segment presses against the surface in response to the body deforming any one of the first segment or the second segment. The first segment may release the pressure of the first segment against the surface. In some embodiments, the first segment releases the pressure of the first segment against the surface in response to the second segment pressing against the surface. In other embodiments, the first segment releases the pressure of the first segment against the surface in response to the deforming of any one of the first segment or the second segment. In some embodiments, the body deforms any one of the first segment or the second segment. The first segment may press against the surface in response to the body deforming any one of the first segment or the second segment. In some embodiments, the second segment releases the pressure applied by the second segment against the surface. In other embodiments, the body contracts any one of the first segment or the second segment in response to the releasing of the pressure applied by the second segment against the surface.

The body may deform any one of the first segment or the second segment by contracting or extending the first or the second segments. Sometimes, the body deforms any one of the first segment or the second segment by bending or straightening the first or the second segments. In other embodiments, the body deforms any one of the first segment or the second segment by twisting or untwisting the first or the second segments. In further embodiments, the body deforms any one of the first segment or the second segment by turning or rotating the first or the second segments.

In some aspects, the present disclosure is related to a method for creating a movement of an autonomous apparatus by deformation of a body of the autonomous apparatus. An autonomous apparatus may provide a body comprising a plurality of segments. A first segment of the plurality may press against a surface. The surface may be any surface the body touches, sits on or interfaces with. The body may deform at least a second segment of the plurality. In some embodiments, at least the second segment is deformed by contracting or shrinking at least the second segment. In other embodiments, at least the second segment is deformed by bending or twisting at least the second segment. In further embodiments, the body deforms at least the second segment of the plurality in response to the first segment pressing against the surface.

A third segment of the plurality may press against the surface. Sometimes, the third segment presses against the surface in response to the deforming of at least the second segment by the body. The first segment may release pressure applied by the first segment against the surface. In some embodiments, the first segment releases the pressure applied by the first segment against the surface in response to the third segment pressing the surface. In other embodiments, the first segment releases the pressure applied by the first segment against the surface in response to the body deforming at least the second segment.

In some embodiments, the body deforms at least the second segment. In other embodiments, at least the second segment is deformed by extending or expanding at least the second segment. In yet other embodiments, at least the second segment is deformed by unbending or straightening or untwisting at least the second segment. In further embodiments, the body deforms at least the second segment in response to the first segment releasing the pressure applied by the first segment against the surface. The first segment may press against the surface in response to the deforming of the at least second segment. In some embodiments, the first segment may press against the surface responsive to the type of deformation by at least the second segment, such as expanding or shrinking, extending or contracting, twisting or untwisting. The third segment may release the pressure of the third segment against the surface. In some embodiments, the third segment releases the pressure in response to the deformation by at least the second segment. The body may deform at least the second segment in response to pressing by the first segment against the surface. In some embodiments, the body contracts at least the second segment in response to the third segment releasing the pressure applied against the surface.

### BRIEF DESCRIPTION OF THE DRAWINGS

Features and advantages of the present invention, described above, as well as other features and advantages will become more apparent from the detailed description set forth below when taken in conjunction with the drawings, in which like reference characters identify corresponding elements throughout.

In the drawings, like reference numbers generally indicate identical, functionally similar, and/or structurally similar elements.

FIG. 1A and FIG. 1B are illustrations depicting an embodiment of a body comprising three segments and two actuators.

FIG. 2A and FIG. 2B are diagrams presenting an embodiment of a body having any number of segments and any number of actuators.

FIG. 3A is an illustration depicting an embodiment of a soft-bodied robot which is shaped like a caterpillar.

FIG. 3B is an illustration introducing an embodiment of a leg of the body along with crochets and actuators.

FIG. 4A and FIG. 4B are diagrams of an embodiment which includes additional features, such as control units, pressure controllers, sensors, valves, membranes, processing units, power supplies, and more.

FIG. 5 is a flow diagram presenting steps of an embodiment of a method for controlling the movement of the body of a soft-bodied robot by deforming the segments of the body via actuators.

FIG. 6 is a flow diagram presenting steps of an embodiment of a method for producing movement of the body of a soft-bodied robot.

### DETAILED DESCRIPTION

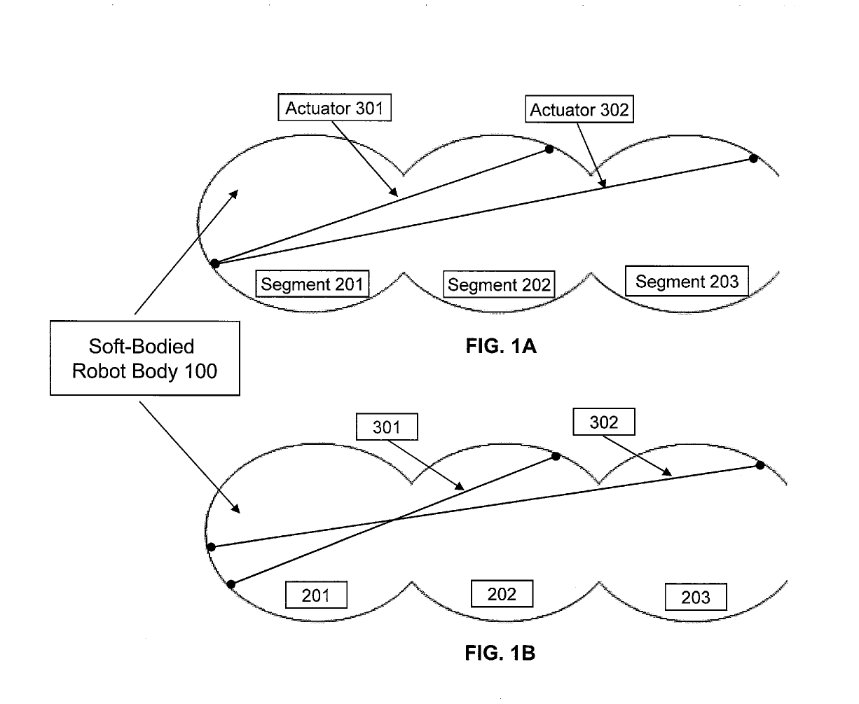

Referring now to FIG. 1A, a soft-bodied robot that has a body 100 divided into three segments 200 is illustrated. The body 100 further comprises two actuators 300 managing and controlling the movement of the body 100. In brief overview, the body 100 is divided into concatenated segments 200 which are interconnected by actuators 300. Segment 202 of the body 100 is connected with segments 201 and 203, while the segments 201 and 203 are not connected to each other. Segments 200 are shaped as ovals, however the segments 200 may also comprise any other shape. The neighboring segments 201, 202 and 203 have an open area in between the, indicating the body having a hollow chamber or cavity that extends through the body. The inside of the body 100 houses actuators 300. Actuators 300 interconnect neighboring components of 200 providing the means of control of deformation and reshaping of the body 100. The actuators 300 are positioned within the body 100 to produce the desired movement. The actuators 301 and 302 are illustrated having two ends. Actuator 301 attaches to an interior of the segment 201 and an interior of the segment 202. Actuator 302 attached to the interior of the segment 201 and an interior of the segment 203.

Still referring to FIG. 1A, a soft-bodied robot may be any autonomous or semi-autonomous platform capable of producing movement by morphing, reshaping, bending, straightening, twisting, untwisting, contracting, extending, shrinking or expanding. In some embodiments, a soft-bodied robot may be connected to an outside device and may receive instructions, signal or power from a source outside of the soft-bodied robot body. In other embodiments, soft-bodied robot is an independent unit producing movement and performing functionality independently. The soft-bodied robot may be an autonomous or a semi-autonomous platform. The soft-bodied robot may move or operate independently from any other input or instruction or may receive wireless inputs, data or instructions. In some embodiments, a soft-bodied robot executes instructions and moves upon receiving of instructions from another device, another user or another source of communication, such as a remote control. The soft-bodied robot may move, operate or trigger functionality in response to one or more instructions or controls stored within the soft-bodied robot body 100. The soft-bodied robot may comprise at least some components, devices or subsystems inside of the body 100, on the body 100 or outside of the body 100. In some embodiments, all of the components, devices or subsystems of the soft-bodied robot are comprised within or on the body 100. The soft-bodied robot may use one or more components to produce, control or manage movement of the soft-bodied robot. In some embodiments, the soft-bodied robot uses one or more components to perform specific functionality, such as detecting, recording, measuring, communicating or data gathering.

The soft-bodied robot may be manufactured from any material having soft, morphing, deformable, flexible, stretchable, contractible or elastic properties. The soft-bodied robot may comprise an enclosure or a shell that includes, at least in part, a material possessing soft properties or the soft material. The material possessing soft properties, or the soft material, may be any flexible, elastic, deformable, soft, stretchable, morphable, contractible or bendable material. The material possessing soft properties, or the soft material, may be repeatedly and easily bent, twisted, contracted, expanded, shrunk, stretched and still be capable to return to its original form and shape. The material possessing soft properties, or the soft material, may be any material which in Young's modulus or the modulus of elasticity for the soft-bodied robot body 100 exhibits between 0.001 and 5 GPa of pressure. In some embodiments, a soft-bodied robot comprises one or more components of the soft-bodied robot which are not soft materials. For example, in some embodiments a soft-bodied robot comprises one or more of rigid, sturdy or inflexible components. Sometimes, the soft-bodied robot may include any number of components or devices, such as electronic, electrical, pneumatic, mechanical, electromechanical, optical, or wireless devices. In some embodiments, the soft-bodied robot comprises devices, apparatuses or components performing specific functions or tasks, such as sensing or detecting movement, sensing of temperature, humidity, sound, light, pressure, or any other feature of the environment surrounding the soft-bodied robot. In further embodiments, the soft-bodied robot comprises a body 100 enclosing a number of: detectors, sensors, transducers, wireless receivers or transmitters, batteries, electrical circuits or devices, power supplies or actuators. In other embodiments, the soft-bodied robot comprises components, subcomponents, devices, systems or subsystems for performing any functionality such as data gathering, sensing or detection of pressure, movement, light, temperature or sound.

The body 100 may be any enclosure, shell comprising any material which encloses one or more components of the soft-bodied robot inside of the body 100. Components enclosed within the body may be any components, such as actuators 300, devices such as controllers, batteries, memory and similar. The body 100 may be divided or sectioned into one or more segments 200 which may be connected to each other. In some embodiments, the body 100 is an enclosure, packaging, camouflage, or a protective shell around a number of components, devices or systems comprised within the body 100 of a soft-bodied robot. In further embodiments, the body 100 is a piece of flexible, deformable, stretchable, contractible material enclosing components of a soft-bodied robot 100. The body 100 may comprise a material fashioned into a shape forming compartments, such as segments 200. In some embodiments, the body 100 encloses components, subcomponents, systems or subsystems of the soft-bodied robot within the body 100. The body 100 may form, shape or comprise a plurality of segments 200. In some embodiments, the segments 200 of the body 100 are concatenated segments which may be connected to each other. In further embodiments, the body 100 comprises a cavity or a hollow section within the body 100 that extends through one or more segments 200. In other embodiments, the cavity or a hollow portion of the body 100 may be include only a fraction of a segment 200. The cavity of the body 100 may be filled with gas, gel or any flexible, contractible or stretchable material. In some embodiments, the cavity of the body 100 houses one or more components, such as actuators 300, control devices, memory and more.

The body 100 may comprise any soft material or the material possessing soft properties. The material possessing soft properties, or the soft material, may be any material that is repeatedly and easily bent, twisted, contracted, expanded, shrunk, stretched and that still returns to its original form and shape when the stress is not applied. The material possessing soft properties, or the soft material, may be any material which in Young's modulus or the modulus of elasticity for the soft-bodied robot body 100 exhibits between 0.001 and 5 GPa of tensile stress over tensile strain. In some embodiments, the material possessing soft properties, or the soft material, has Young's modulus of anywhere between 0.001 and 0.01. In other embodiments, soft material has Young's modulus of anywhere between 0.01 and 0.05. In further embodiments, soft material has Young's modulus of anywhere between 0.05 and 0.1. In still further embodiments, soft material has Young's modulus of anywhere between 0.1 and 0.5. In still further embodiments, soft material has Young's modulus of anywhere between 0.5 and 1. In further embodiments, soft material has Young's modulus of anywhere between 1 and 2. In yet further embodiments, soft material has Young's modulus of anywhere between 2 and 3. In still further embodiments, soft material has Young's modulus of anywhere between 3 and 4. In yet further embodiments, soft material has Young's modulus of anywhere between 4 and 5. In still further embodiments, soft material has Young's modulus of anywhere between 5 and 10. The material possessing soft properties may be any material that elastic, stretchable, deformable and bendable under any temperature range and in any conditions. The soft material may exhibit any of the soft properties in any conditions, such as any temperature or pressure range. The soft material may exhibit soft properties in any temperature such as, −200 C, −150 C, −100 C, −80 C, −60 C, −40 C, −20 C, 0 C, 20 C, 40 C, 60 C, 80 C, 100 C, 120 C, 140 C, 160 C, 180 C, 200 C, 220 C, 240 C, 260 C, 280 C, 300 C, 320 C, 340 C and 360 C. In some embodiments, the body 100 comprises a soft material, such as any material which is stretchable, flexible, elastic or otherwise capable of being repeatedly reshaped, morphed or deformed by the body 100. The body 100 may include any number of materials. In some embodiments, the body 100 includes flexible polymeric material or an elastic polymeric material. In some other embodiments, a part of the body 100 includes an amorphous polymer. In further embodiments, a part of the body 100 comprises a plurality of long polymer chains cross-linked during the curing process. In specific embodiments, a part of the body 100 comprises an elastic hydrocarbon. In many embodiments, a part of the body 100 comprises a form of styrene, such as for example, a polystyrene. In other embodiments, a part of the body 100 comprises polybutadiene. In some embodiments, a part of the body 100 comprises ethylene or propylene. In other embodiments, a part of the body 100 includes a silicone elastomer. In some other embodiments, a part of the body 100 comprises a rubber. In yet further embodiments, a part of the body 100 comprises latex or nitrile. A part of the body 100 may comprise a synthetic elastic material or a natural elastic material. In some embodiments, a part of the body 100 comprises a silicone elastomer, such as DragonSkin™. In some other embodiments, a part of the body 100 comprises a material for actuation, extension or contraction, such as Flexinol™. In further embodiments, a part of the body 100 comprises a biopolymeric composite material. In yet further embodiments, a part of the body 100 comprises a soft, elastic, flexible material that is biodegradable and environmentally friendly. Sometimes, the part of the body 100 comprises a biopolymer material. In some embodiments, a part of the body 100 comprises a natural elastomer, such as resilin for example. In other embodiments, a part of the body 100 comprises natural materials, such as silk for example. In yet other embodiments, natural elastomers or natural materials may be mimicked, copied or synthesized in a laboratory or a factory to exhibit similar properties and be used for the body 100. In further embodiments, a part of the body 100 comprises an epoxy, such as a conductor doped conductive epoxy. Any part of the body 100 may comprise any material allowing the soft-bodied robot to change its own shape, volume, length, thickness, width or height during the course of movement of the soft-bodied robot.

The body 100 may comprise any shape. The body 100 may be shaped into a string of concatenated segments 200. Sometimes, the soft-bodied robot, or the body 100 may be shaped to include all the components such as the segments 200 and the actuators 300 within the body 100. The body 100 may be shaped to comprise any of these components outside of the body 100. The body 100 may be shaped into a cylindrical shape of any length or width. Sometimes, the cylindrical shape of the body 100 may be further fashioned into segments 200 or compartments. The segments may be slightly spherical, thus being visibly distinguished from each other. Sometimes, the body 100 is a segmented cylindrical body enclosing a concentric cavity. The concentric cavity may provide location for story soft-bodied robot's payload, such as sensors, controllers, systems and subsystems and power supplies or batteries. In some embodiments, the outside shell of the body 100 and the cavity inside are made up of the same or substantially similar material. Sometimes, the outside shell and the cavity are made up of two different materials. In other embodiments, the segments 200 are concatenated in a daisy-chain fashion, each segment 200 connecting only one or two of other segments 200. In some embodiments, the segments 200 of the body may be connected to three or more segments. In other embodiments, the body 100 is shaped such that segments are not obvious, visible or marked. The segments may be determined or defined by locations wherein the actuators 300 are attached. In some embodiments, the body 100 may be implemented using 3D printed molds and a vacuum casting system. In further embodiments, the body 100 may comprise caterpillar-like body shells having thickness of anywhere between 1 and 2 millimeters. The number of segments as well as their shape may vary between various embodiments and various design applications.

Sometimes, the body 100 is shaped such that it closely resembles the body of an animal, such as a worm, a larvae, an earthworm, a snake, or a caterpillar. In some embodiments, the body 100 the looks, the shape, the size or the movement of an animal or an insect. In other embodiments, the body 100 mimics or resembles a caterpillar, such as a menduca sexta. In some other embodiments, the body 100 comprises a number of segments substantially resembling portions of a body of an insect, such as a menduca sexta caterpillar. The body 100 may be shaped such that it forms or comprises a groove or a plurality of grooves. The grooves may be located in between of the segments 200 of the body 100. In some embodiments, the grooves are circumferential. In some embodiments, the body 100 is cylindrically shaped, further comprising segments 200 having a radius larger than the radius of the cylindrical body 100 between the segments 200. In such embodiments, grooves may be formed between the segments 200, or on the segments themselves. Grooves may be positioned anywhere on a segment 200, or anywhere else on the body 100, and may be of any length and in any direction or orientation. The grooves may have sizes and shapes to maximize the soft-bodied robot's grip on the ground while moving.

Still referring to FIG. 1A, segments 201, 202 and 203, also referred to as segments 200, may be any part, segment, fragment or portion of a body 100. In some embodiments, a segment 200 is a part of a body 100 enclosing a specific volume of a body 100. The segment 200 may be a portion of the body 100 having a hollow interior and enclosing a specific volume of interior of the portion of the body 100. In some embodiments, the segment 200 is a specific section of body 100 comprising a specific volume inside of the body 100. In other embodiments, the segment 200 is a portion of the body 100 having a spherical, or at least a partially spherical shape. The segments 200 may be hollow or filled, and may comprise any number of soft-bodied robot components, systems or subsystems.

A segment 200 may comprise any number of materials comprised by the body 100. In some embodiments, a segment 200 comprises an elastomeric material. In some other embodiments, a segment 200 comprises a flexible polymeric material or an elastic polymeric material. In yet other embodiments, a segment 200 comprises an amorphous polymer existing above own glass transition temperature. In further embodiments, a segment 200 comprises a plurality of long polymer chains cross-linked during the curing process while producing the material. In yet further embodiments, a segment comprises an elastic hydrocarbon. In some embodiments, a segment 200 comprises a form of styrene such as a polystyrene. In other embodiments, a segment comprises polybutadiene. In yet other embodiments, a segment comprises ethylene or propylene. In further embodiments, a segment 200 comprises a silicone elastomer. In some embodiments, a segment 200 comprises a natural flexible material, such as a rubber or a silk. In other embodiments, a segment 200 comprises latex or nitrile. A segment 200 may comprise a synthetic elastic material or a natural elastic material. Sometimes, the segment 200 comprises both the synthetic elastic material and the natural elastic material. In some embodiments, a segment 200 may comprise any flexible or elastic deformable material.

In some embodiments, a segment 200 may be hollow section of a body 100. In other embodiments, a segment 200 is pressurized, or filled with air. In yet other embodiments, the segment 200 is pressurized, or filled with a liquid. In some other embodiments, the segment 200 is pressurized, or filled with a gel. In some other embodiments, a segment 200 is in part filled with a solid which may or may not exhibit elastic or flexible properties. In many embodiments, a segment 200 is pressurized with a plurality of beads, which may or may not comprise a soft material. A segment 200 of a body 100 may be pressurized differently than another segment 200 of the same body 100. In some embodiments, a segment 200 of a body 100 may be hollow while another segment of the same body 100 is not hollow. In further embodiments, a hollow segment 200 filled with a substance or a material may be a part of a body 100 which comprises another segment 200 not filled with any substance or any material.

A segment 200 of the body 100 may be shaped in a variety of ways. In some embodiments, a segment 200 is a spherically shaped component of a cylindrically shaped body 100. In other embodiments, a segment 200 comprises a bump or a lump protruding from the segment 200, thus making the segment 200 elongated in one more directions. Sometimes, a segment 200 comprises a plurality of bumps or lumps, thus making the segment 200 elongated or shaped differently from the way other parts of the segment 200 or the body 100 are elongated or shaped. A segment 200 of a soft-bodied robot may be shaped to comprise one or more legs, which may be bumps, lumps or deformations sticking out of a side of the segment 200. A segment 200 may be shaped to include a groove, a dent or a roughened surface in order to grip the surface over which the soft-bodied robot is moving. Sometimes, any portion of a segment 200 of a soft-bodied robot may be shaped in a way to improve movement or a grip of the soft-bodied robot over the surface the soft-bodied robot is moving over. The segment 200 may be shaped to include one or more sharp points, pins or crochets to help with gripping the surface over which the soft-bodied robot moves. A segment 200 may be shaped to include any number of features, components or shapes which facilitate or provide the segment 200 with ability to apply pressure against the surface the soft-bodied robot is moving over. Such features, components or shapes may be an integral part of any segment 200 or additional features added to the segment 200.

Still referring to FIG. 1A, an actuator 300, such as actuators 301 and 302, may be any part, component, device or a piece of material within, or on, the body 100 which produces or induces a movement of any portion of the body 100. Actuators 300 may be any devices, components, units or pieces of material that deform, morph, shrink, expand, contract, extend, bend or straighten, twist or untwist. Actuators 300 may be any devices, units, components or pieces of material which deform or move and induce deformation or movement on any component of the body 100 to which they are attached. In some embodiments, an actuator 300 is a device using electrical current to produce a mechanical movement for the soft-bodied robot. In other embodiments, an actuator 300 is a piece of material which uses a voltage or an electrical current to produce a movement. Sometimes, an actuator 300 comprises a shape memory allow (SMA) which creates a movement in response to the current or voltage applied. In some embodiments, an actuator 300 is any device, part, component or material attached to one or more segments 200 of a body 100 producing movement to deform or reshape the one or more segments 200 of the body.

An actuator 300 may be used as a tool or a means to achieve a movement of the body by deforming one or more segments 200. In some embodiments, actuators 300 associated with a body 100 are enclosed within the body. In other embodiments, an actuator 300 may comprise only two ends, while in other embodiments an actuator may comprise any number of ends. The ends of the actuator 300 may be attached to different sections of the body 100 and upon producing the movement may reshape the body 100 in response to the movement. In some embodiments, an actuator 300 is attached to a body 100 via two or more points within the body in order to apply force exerted by the actuator onto the body 100 via the points of contact. In other embodiments, an actuator 300 may be completely enclosed within the body 100 or within a segment 200 of the body 100. In yet some embodiments, an actuator 300 is not enclosed within the body 100. Sometimes, an actuator 300 may be on the surface or along the surface of the body 100.

An actuator 300 may comprise a single material or a number of materials. In some embodiments, an actuator 300 comprises a shape memory alloy (SMA). In further embodiments, SMA wires are attached to the wall of the body 100 without puncturing the wall of the body 100. Segments 200 of the body 100 may be actuated or moved using one or more SMA coils. An actuator 300 may comprise one or more SMA wires and SMA coils. In some embodiments, an SMA wire of the actuator 300 may be coiled up into one or more coils. An actuator 300 may also comprise any type of polymer. In some embodiments, an actuator 300 comprises an electroactive polymer. In some embodiments, an actuator 300 comprises a piezoelectric component creating a movement. In other embodiments, an actuator 300 comprises a hydraulic component creating a movement. In certain embodiments, an actuator 300 comprises a mechanical component creating a movement. In some embodiments, an actuator 300 comprises an elastic polymer. In further embodiments, an actuator 300 comprises an elastomeric material. In yet further embodiments, an actuator 300 comprises a motor or a micro-motor, or is powered by a motor or a micro-motor. In some embodiments, an actuator 300 comprises an amorphous polymer. In some embodiments, an actuator 300 comprises a silicone elastomer. In other embodiments, an actuator 300 comprises a rubber. An actuator 300 may comprise any material or a component enabling a shift of any other energy into a mechanical energy and producing movement. Even though these illustrations present actuators 300 having only two ends, actuators 300 may comprise any number of ends which may be connected to any part of any segment 200 or even over a plurality of segments 200 in any variation or any arrangement.

Soft-bodied robot, or component of a soft-bodied robot may be designed, shaped or sized according to results of testing using a simulator. The simulator may be any software, hardware or a combination of hardware and software for simulating any one or more of components of the soft-bodied robot. Simulator may comprise any number of software applications, programs, algorithms, scripts or functions that may be implemented via any processing unit or a computing unit to control or manage movement of the soft-bodied robot. In some embodiments, the simulator comprises a software, applications and algorithms that simulate a motion of a soft-bodied robot. In other embodiments, the simulator comprises one or more Phys-X simulations. Phys-X simulations may generate or use one or more of caterpillar-like structures that may be generated or implemented in order to test aspects of the soft-bodied robot. In further embodiments, simulator comprises models of one or more designs of the soft-bodied robot. The models may be tested in the simulator depending on the number and location of actuators 300, sizes and positioning of the segments 200, number of legs 350 and more. In some embodiments, the simulator employs positional grip and non-linear actuators 300 which are modeled after Manduca Sexta caterpillar muscles. The non-linear actuators 300 may be designed, shaped, and sized to simulate movement of each of the muscles of the Manduca Sexta caterpillar. In further embodiments, the simulator tests or calculates effects of material properties, such as soft properties of the body 100. In still further embodiments, the simulator tests or calculates strengths or effects of actuators 300, activation sequences or movement sequences of actuators 300 used to produce a coordinated movement. In still further embodiments, sequences of movements for one or more actuators 300 may be stored in the controller or a memory unit of a soft-bodied robot. The sequences of movements may be retrieved and used by the soft-bodied robot for generating and controlling the movement of the body 100.

Referring now to FIG. 1B, a body 100 comprising segments 201, 202 and 203, interconnected by actuators 301 and 302 is illustrated. In brief overview, segment 202 is connected to segments 201 and 203, such that segments 201 and 203 are not connected to each other. The body 100 also comprises actuators 301 and 302 which are connected to a two different points inside the segment 201. This is different from the embodiment depicted by FIG. 1A which illustrates actuators 301 and 302 connected to a same point inside the segment 201. FIG. 1B further presents actuators 300 interconnecting the segments and producing movement.

Since actuators 300 may connect to any portion of segments 200, an inside portion of any segment 200 may be defined as comprising all of the points of the inner surface of that same segment 200. Thus, in both FIG. 1A and FIG. 1B, actuators 301 and 302 connect the inner surface of the segment 201 to segments 202 and 203, regardless that in FIG. 1A the actuators 301 and 302 connect the segments 202 and 203 to the same inside portion of the segment 201, while in FIG. 1B actuators 301 and 302 connect 202 and 203 to two different inside portions of the segment 201. Similarly, any actuator 300 may use connect any inside or outside points of any segment 200 to either inside or outside of any other segment 200. Similarly, any number of actuators 300 may connect to any single point of any segment 200 via one end of the actuator 300 and to any other point of the same or a different segment 200 on the other end of the actuator 300.

In further overview of FIG. 1B and FIG. 1A, both illustrations show embodiments in which actuator 301 deforms segments 201 and 202 and actuator 302 deforms segments 201, 202 and 203. However, actuator 301 may be connected to any point of the inside surface of segment 201 via one end and to any point of inside surface of segment 202 on the other end. In some embodiments, actuator 301 is not necessarily straight. Sometimes, the actuator 301 may be curved and connected to inside portions of segments 201 and 202 in a way to create a bend or a twist on one side of the body 100 when contracted. In some embodiments, the actuator 301 may be shaped or positioned such to create a band or a twist between the segments 201 and 202 in a certain direction. In other embodiments, the actuator 301 may be shaped or positioned such to create a contraction or an extension of the segments 201 and 202 along a certain direction. Similarly, actuator 302 may be shaped or positioned to create a bend, twist, contraction or extension of segments 201, 202 and 203. In some other embodiments, actuators 301 and 302 may be positioned and shaped such that, in combination with other actuators 300 they induce a shrinkage or an expansion of any one of or any combination of segments 200 of the body 100.

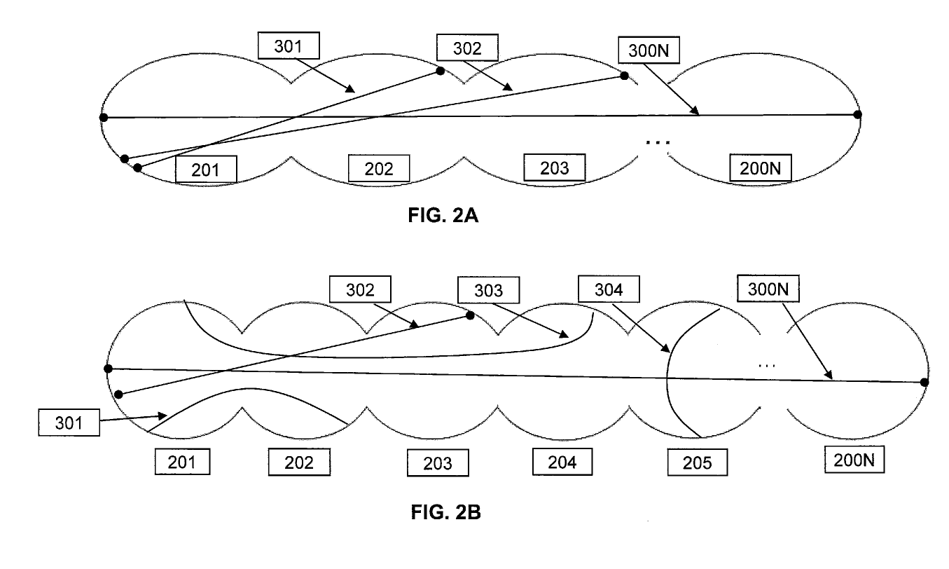

Referring now to FIG. 2A, an embodiment of a soft-bodied robot is depicted having any number of segments 200 and actuators 300. FIG. 2A presents the body 100 that has segments 201, 202, 203 through 200N. The segments 200 are concatenated, wherein each of the segments 200 connects to only one or two other segments 200. FIG. 2A also illustrates actuators 301, 302 and 300N. The actuators 300 are located inside of the body 100 and interconnect various segments 200. Actuator 301 connects to the interior of segment 201 via one end and the interior of segment 202 via the other end. Similarly, actuator 302 interconnects the segments 201 and 203, while actuator 300N interconnects segments 201 and 200N.

In further overview, FIG. 2A illustrates a body 100 having any number of segments 200 interconnected by any number of actuators 300. The separation between the segments 203 and 200N illustrated in FIG. 2A further features three dots which indicate that there may be any number of segments 200 positioned in between segments 203 and 200N. The body 100 may comprise any number of actuators 300 interconnecting any of the segments 200 of the body 100. The actuator 300N, for example, is placed inside the body and interconnects segments 201 and 200N while going through all the segments in between the segment 201 and the segment 200N. Similarly, there may be any other number of actuators which may interconnect any other two segments of the body 100 in any way, orientation or via any point of reference. In some embodiments, the body 100 comprises a relatively small amount of segments, such as five, ten, twenty or up to fifty segments 200. In other embodiments, the body 100 comprises a lot of segments, such as fifty to a hundred, or a thousand or a few thousand segments. In further embodiments, segments 200 of the body 100 are interconnected by relatively few actuators 300, such as five, ten, twenty or up to fifty actuators 300 positioned anywhere within the body 100. In yet further embodiments, the body 100 is interconnected a lot of actuators 300, such as fifty to a hundred, or a thousand or a few thousand actuators 300.

Actuators 300 may be produce movement by deforming specific segments 200 or a plurality of segments 200. In some embodiments, actuator 302, being connected to segments 201 and 203 contracts and deforms the segments 201, 202 and 203 by shrinking or contracting these segments. In other embodiments, actuator 302, being connected to the first segment 201 and the last segment 200N, contracts and deforms all the segments 201 through 200N by shrinking or contracting these segments. Similarly, segments 302 or 300N may extend or expand, thus expanding the segments 200 of the body 100 they are affecting. In some embodiments, an actuator 300 may be interconnecting two or more portions of the same segment 200, thus deforming this particular segment by contracting or expanding the portions of the segment 200 to which the actuator 300 is attached. Similarly, actuators 300 may twist or untwist, thus twisting or untwisting the segments of the body 100 they are interconnecting along with all the segments 200 in between. In some embodiments, actuators 300 may bend or straighten, thus bending or straightening segments 200 of the body 100 the actuators 300 are interconnecting along with all the segments 200 in between them. In some embodiments, a plurality of segments 300 may move in a coordinated fashion to create a coordinated movement of the body 100 of the soft-bodied robot. For example, a number of segments 300 interconnecting a plurality of segments 200 of the body 100 may be moving in coordination with other segments 300 to produce a shrinking movement of the plurality of segments 200 of the body 100. By coordinating the movement of a large number of actuators 300 the soft-bodied robot may move by crawling, cantilevering, twisting, bending, rolling or even flipping.

Referring now to FIG. 2B an embodiment of a soft-bodied robot having any number of segments 200 and actuators 300 is depicted. FIG. 2B illustrates the body 100 having segments 201, 202, 203, 204, 205 through 200N, where N can be any number. The segments 200 are concatenated, wherein each of the segments 200 connects to only one or two other segments 200. Actuators 301, 302, 303, 304, 305 and 300N interconnect various portions of the body 100. Actuator 301 is bent and connects to the interior of segment 201 via one end and the interior of segment 202 via the other end. Actuator 302 is shaped differently from the actuator 301 and interconnects segments 201 and 203. Actuator 303 is also shaped differently from other actuators and interconnects segments 201 and 204. Actuator 304 interconnects two different portions of the segment 205 to each other, while actuator 300N interconnects segments 201 and 200N while going through all the segments in between.

In further overview, FIG. 2B illustrates actuators 300 interconnecting segments 200 of the body 100 while going through or traversing any number of segments 200 in between the two interconnected segments. In some embodiments, actuator 303 interconnects segments 201 and 204, while traversing or going through the segments 202 and 203. The actuator 303 may deform and thus deform all the segments affected by the segment 303, namely segments 201, 202, 203 and 204. Similarly, a segment 300 may interconnect a segment 201 and segment 205, while traversing or going through segments 202, 203 and 204. The segment 300 may deform and thus cause the movement or deformation of segments 201, 202, 203, 204 and 205. In some embodiments, an actuator 300 may interconnect segments 201 and 206, while traversing segments 202, 203, 204 and 205, thus enabling deformation and movement of segments 201 through 206. Similarly, an actuator 300 may interconnect segments 200 which are five segments 200 apart from each other, and may deform the interconnected segments 200 and all the segments 200 in between. In some embodiments, an actuator 300 interconnects segments 200 which are six segments 200 apart from each other and deforms the interconnected segments 200 and all the segments 200 in between them. In many embodiments, an actuator 300 may interconnect segments 200 which are seven segments 200 apart from each other and deform the interconnected segments 200 and all the segments 200 in between. Similarly, an actuator 300 may interconnect eight, nine, ten, twenty, fifty or any number of segments apart from each other and deform the interconnected segments along with all the segments 200 in between. The actuator interconnecting such two segments may bend, twist, stretch, contract, extend or shift in any way or in any direction, thus inducing movement of the two segments interconnected and all the segments in between the two segments. In some embodiments, the actuator 300 interconnecting two segments may be connected to the ends of the segment 200 only inducing movement of the segments 200 in between the two interconnected segments 200 to which the actuator is attached to and without deforming or moving the two segments to which the actuator 300 is attached to.

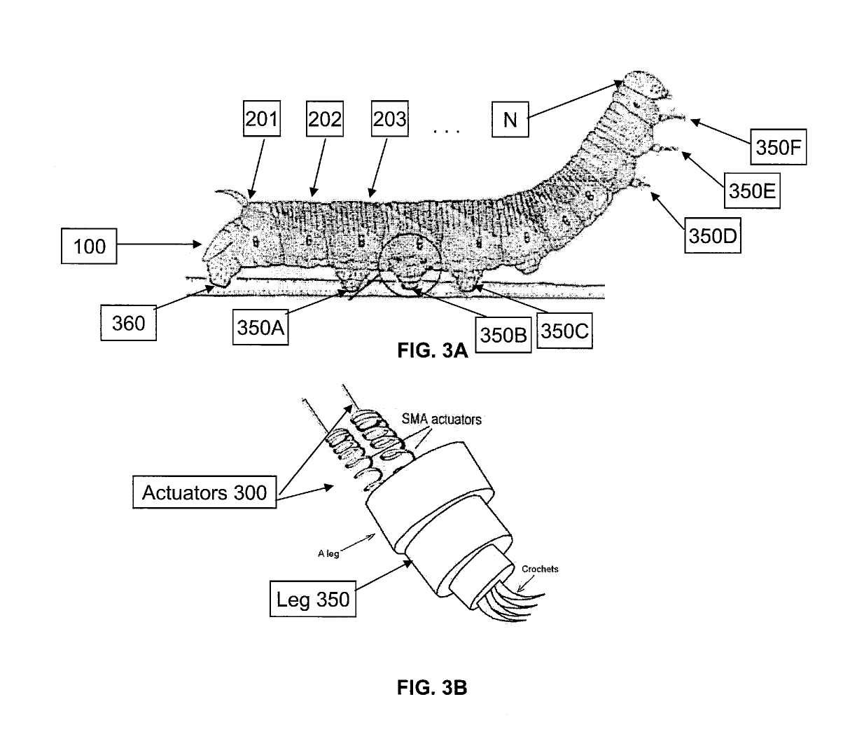

Referring now to FIG. 3A, an embodiment of a soft-bodied robot shaped like a caterpillar is illustrated. In some embodiments, the caterpillar shaped soft-bodied robot is more specifically shaped to resemble a Manduca Sexta caterpillar. FIG. 3A depicts the body 100 of the soft-bodied robot comprising a plurality of segments 200 which resemble segments of a body of a caterpillar. The body 100 comprises legs, or sets of legs 350 protruding from the bottom portion of the body 100. Legs 350A, 350B and 350C are shaped as bumps protruding from the bottom portion of the body 100, while legs 350D, 350E and 350F are thinner and are shaped as sharp tips or crochets rather than bumps. The body depicted in FIG. 3A also comprises a terminal leg 360 protruding from a bottom portion of the segment 201. The body 100 further comprises grooves on top and bottom portions of the body, as well as grooves positioned longitudinally along the separations between the segments 200. FIG. 3A further depicts features similar to the horns protruding from the segment 201, thus further providing resemblance to the caterpillar.

In further overview, the caterpillar shaped robot illustrated by FIG. 3A may be of the same size, or a size substantially similar to the size a real-life caterpillar, such as the caterpillar Manduca Sexta. Segments 200 of the caterpillar shaped soft-bodied robot may be shaped to mimic or resemble portions of body of a caterpillar. The sizes and shapes of these segments 200 may vary between different sections of the body 100. Some segments 200 may strongly resemble the caterpillar while other segments 200 may be different than those of the caterpillar. Some segments 200 may comprise a leg or a set of legs protruding from the bottom part of the differently throughout the body 100. Some segments 200 may not comprise any legs 350 or bumps. Segments 200 are in FIG. 3A as comprising a plurality of grooves which varies from a segment to a segment. Some segments 200 may comprise a leg 350, such as a terminal leg or a set of legs 350.

Sometimes, the body 100 of a soft-bodied robot resembling a caterpillar may comprise a number of concatenated segments that vary in shape and size. Such body 100 may comprise segments 200 which include a variety of sets of legs and a terminal leg. Segments 200 of the body 100 illustrated by FIG. 3A for example, comprise different sets of lets 350 and a terminal leg. In some embodiments, segments 200 comprise a variety of grooves which may differ from segment 200 to segment 200. Some segments 200 interface with other segments 200 in ways which differ from the way other segments 200 interface with different segments of the body. Some segments 200 interface with other segments via more gradual transitions, while other segments interface with other segments via more abrupt interface regions.

Referring now to FIG. 3B, an embodiment of a leg 350 is illustrated. The leg 350 may be any bump, one or more sharp tips, crochets or hooks protruding from the body 100 or any segment 200. Body 100 may comprise a leg, a leg of a set of legs or a terminal leg at the end of the body 100. The leg 350 may comprise any number of cylindrical sections, crochets and SMA (shape memory alloy) actuators. In some embodiments, the leg comprises a SMA wire. In further embodiments, the leg comprises a SMA coil. The leg illustrated comprises a plurality of crochets attached to a bottom section of a smallest of three cylindrical sections. The crochets may be attached perpendicularly to the one of the two sides of the cylindrical sections which have a flat surface. The other flat surface of the cylindrical section may be attached to a flat surface of a larger middle cylindrical section. The largest cylindrical section is attached to the second flat surface of the middle cylindrical section. Two SMA actuators may be attached perpendicularly to the second flat surface of the largest cylindrical section. The leg 350 may be connected to a body 100 or any segment 200 of a body 100 via SMA actuators. In some embodiments, legs or sets of legs 350 are similar or identical between a plurality of segments 200 of the same body 100. Sometimes, a segment 200 comprises a plurality of sets of legs 350 which may be similar or different to other sets of legs 350. In some embodiments, a leg 350 comprises one or more sharp tips. In other embodiments, a leg 350 comprises one or more hooks. In further embodiments, a leg 350 comprises one or more crochets. In still further embodiments, a leg 350 comprises bumps or lumps of various shapes and sizes. In yet other embodiments, a leg 350 comprises a component having releasable hooks or tips, such as that of a velcro. In still further embodiments, a leg 350 comprises a component having releasable loops, such as that of a velcro. A segment comprising a set of legs 350 may be positioned on any part of the body. A terminal leg or a set of legs 350 may be shaped in any way to enhance the grip of the apparatus on the surface on which it moves.

The leg 350 may be attached to any segment 200 of the body in any number of ways. In some embodiments, the leg 350 may be a part or a portion of the segment 200. In some embodiments, the leg 350 may be attached to an inside portion of the body 100 and not be physically attached to any segment 200 of the body 100. In other embodiments, a leg 350 is associated with a segment but attached to another part located inside of the body 100, the part not being a part of any segment 200 of the body. The leg 350 may be attached to an inside portion of a body through one or more segments 200. In some embodiments, the leg 350 is attached to the body 100 via one or more actuators 300, such as SMA actuators illustrated by FIG. 3B. The leg 350 may be controlled by an actuator or a plurality of actuators connecting the leg to a part of a segment 200 or a part of a body 100. In some embodiments, the leg 350 is an integral part of a segment 200 of a body 100, such as a lump or a bump, protruding from the segment 200 but moved by an actuator 300 or a plurality of actuators 300 within the segment 200.

A leg 350 may comprise a plurality of parts to aid the movement intended for the particular application of the soft-bodied robot. In some embodiments, a leg 350 comprises one or more sharp points to improve gripping of the surface by the soft-bodied robot. The sharp points may be substantially similar to sharp points or loops of a velcro. In some embodiments, the sharp points are components of a velcro. In other embodiments, a leg 350 comprises a hook or a crochet for gripping the surface by the soft-bodied robot. The sharp points, tips, hooks or crochets may be releasable, similarly to the way a velcro is gripping and releasable. A leg 350 may comprise a number of components interfaced together, connected together or stacked together. A leg 350 may comprise one or more parts, components or shapes on the bottom portion of the leg 350 which enhances the grip between the grip and the surface. The leg 350 may be used as a portion of the body 100 which applies pressure on the surface over which the soft-bodied robot is moving. The soft-bodied robot may comprise one or more actuators 300 located at, connected to, or connected close to the leg 350 of the body 100 in order to enable coordinated push of the leg 350 against the surface over which the soft-bodied robot is moving. Similarly, the actuators may control the movement of the soft-bodied robot to enable release of the pressure applied by the soft-bodied robot against the surface. The leg 350 may further comprise any additional features or shapes, such as a groove, a bead, a dent, a roughened surface, a sticky surface or any other feature improving gripping between the leg 350 and the surface.

A leg 350 may consist of any number of materials. In some embodiments, a leg 350 comprises a polymer or an elastomer. In further embodiments, a leg 350 comprises any material comprised by the body 100. In some embodiments, a leg 350 comprises velcro. A leg 350 may comprise a synthetic elastic material, or a natural material, or a combination of both synthetic and natural materials. In a number of embodiments, a leg 350 comprises a biodegradable material, such as any environmentally friendly material which naturally degrades and does not contaminate or negatively impacts the environment. A leg 350 may also comprise a shaft, a screw, a groove or a tip. A leg 350 may comprise any material exhibiting stiffness and sturdiness such as a plastic or a metal for example. A leg 350 illustrated in FIG. 3B may be attached to the body 100 of a soft-bodied robot in a variety of ways. In some embodiments, the leg 350 may be attached to a bottom portion of a segment 200 of a body 100. Sometimes, the leg 350 may be attached to any portion of the body 100. FIG. 3B illustrates a leg 350 comprising three cylindrical segments, connected via their flat surfaces and interfaced with the body via two SMA actuators. However, in a plurality of embodiments, the leg 350 may be connected to the body 100 via any number of actuators 300 of any kind or shape. Sometimes, the leg 350 is connected to the body 100 via a shaft, a screw or is glued to the body 100. Sometimes, the leg 350 is connected to a piece, a section or a component inside of the body 100. A leg 350 may be connected to any portion of the body 100 of a soft-bodied robot in any number of ways.

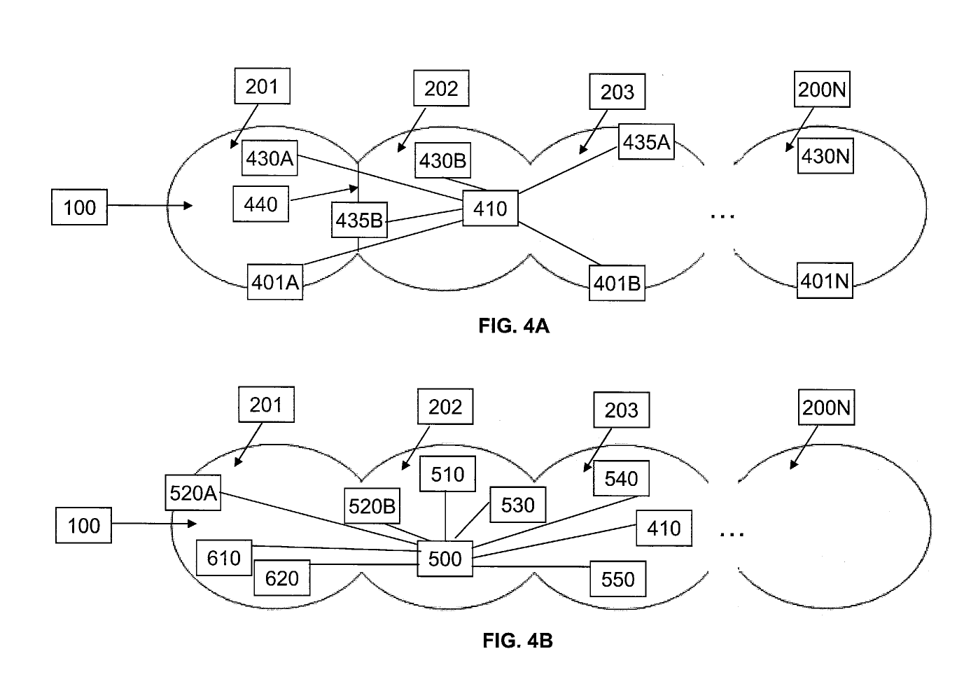

Referring now to FIG. 4A, a number of components and features which may be included inside of a soft-bodied robot are illustrated. FIG. 4A illustrates a soft-bodied robot further comprise additional components or subsystems, such as control systems, pressure controllers, sensors, pressure gauges, valves, memory units, microprocessors, power supplies, receivers, transmitters, control circuits, communication systems and more. As illustrated in FIG. 4A, a body 100 of a soft-bodied robot may comprise components for pressure control of the body 100, or controllers for the movement of the body 100.

In a brief overview, FIG. 4A depicts a soft-bodied robot comprising a system for pressure control of the body 100 having a number of components. The body 100 is illustrated having a plurality of concatenated segments 201 through 200N, where N can be any number. FIG. 4A also depicts a number of separate components within the body 100 which may include a pressure controller 410, pressure sensors 430A-430N, valves 401A-401N, a membrane 440, pressure adjusters 435A and 435B, and a control unit 500.

The body 100 comprising the pressure controlling system may be designed to be leak tight such that it does not leak the substance used for pressurizing. The substance used for pressurizing the body 100 of the soft-bodied robot may be any gas, liquid, gel or components such as beads used for stuffing. In some embodiments, the body 100 wherein the pressure is controlled comprises a segment segregated from another second segment by a membrane used to enable pressurization of one or more segments 200 of the body which are enclosed by the body and the membrane from other parts of the body 100. Sometimes, the seals between the segments may be leak free in order to prevent the leakage between different segments 200 of the body.

The pressure controller 410, illustrated by FIG. 4A is shown connected or interfacing with a number of associated components or subsystems. The pressure controller 410 may be any controller controlling or maintaining pressure within the soft-bodied robot. The pressure controller 410 may comprise logic circuitry, control circuitry, analog or digital circuitry, software, hardware, microprocessors, memory and any other processing or control related components enabling the pressure controller 410 to control pressure within the body 100. In some embodiments, the pressure controller 410 comprises a power supply, a control unit, a power distribution system, a processing unit, a logic unit, a communication unit or any other unit or component enabling it to maintain its operation and communication. In some embodiments, the pressure controller 410 comprises communication circuitry for receiving signals from or transmitting signals to components or devices within the body 100. In a number of embodiments, the pressure controller 410 comprises communication circuitry for receiving signals from or transmitting signals to components or devices outside of the body 100. In some embodiments, a pressure controller 410 comprises circuitry associated with monitoring or control of pressure adjusters, pressure sensors and valves. In a number of embodiments, the pressure controller 410 comprises a memory unit wherein configuration settings or control settings for controlling pressure are stored. In some embodiments, pressure controller 410 is communicating to one or more components or systems associated pressure control, pressure monitoring or pressure adjustment.

Pressure sensors 430A-430N may be any devices, parts or components capable of sensing or measuring pressure. In a number of embodiments, the pressure sensor 430 is a fiber optic pressure sensor. In certain embodiments, the pressure sensor 430 is a mechanical pressure sensor. In some embodiments, the pressure sensor 430 is an electronic pressure sensor. In some embodiments, the pressure sensor 430 is a micro-electromechanical systems pressure sensor. A pressure sensor may comprise a piezoresistive pressure sensing device or a component. In a number of embodiments, the pressure sensor 430 is a semiconductor pressure sensor. In certain embodiments, the pressure sensor 430 comprises a variable capacitance pressure sensor.

In some embodiments, pressure sensors 430 are used for measuring a pressure of a single segment 200 of a body 100, such as for example sensor 430A depicted in FIG. 4A. A pressure sensor 430 may be used for measuring a pressure of a plurality of segments of a body, such as for example sensor 430B depicted in FIG. 4A. A pressure sensor 430 may or may not be connected to a pressure controller directly. Some pressure sensors 430 may communicate using wireless links. A pressure sensor 430 may or may not be communicating to a pressure controller 410. Some pressure sensors 430 communicate with other components instead, such as, for example control unit 500. In some embodiments, the pressure sensor 430 comprises a mechanism or a device for measuring a pressure range above the standard atmospheric pressure. In some embodiments, the pressure sensor 430 comprises a mechanism or a device for measuring a pressure range below the standard atmospheric pressure. In a number of embodiments, the pressure sensor 430 comprises a gauge.

Valves 401A through 401N may be any components, units or apparatuses enabling the exchange of pressures between any two portions of the body 100 or between the body 100 and the outside environment. In some embodiments, the valve 401 may be a component, device or an apparatus enabling exchange of gas or liquid between two neighboring segments 200 of the body 100. In a number of embodiments, the valve 401 is a component, device or an apparatus equalizing the pressure between the body 100 and the outside environment. In a number of embodiments, the valve 401 is a component within a device used for pressurizing the body 100 or one or more segments 200 of the body 100.

In some embodiments, a valve 401 comprises a soft material. In some embodiments, the valve 401 comprises a rigid material or a component. In many embodiments, the valve 401 is entirely made up of soft and flexible materials. In some embodiments, the valve 401 comprises a natural material or a biodegradable material. In a number of embodiments, the valve 401 is deformable. Sometimes, the valve 401 may allow a pressure exchange or a flow only in one direction, such as from one segment 200 to another, or from the body 100 to outside of the body 100. In some embodiments, the valve 401 allows for bidirectional flow or a flow in more than one direction. Sometimes, the valve 401 comprises a sensor or a read-back mechanism. In many embodiments, the valve 401 is controlled by a controller, such as a pressure controller 410 or a control unit 500.

A membrane 440 may be any material or a portion of a material used to used to segregate two or more portions of a body from other portions of the body. In some embodiments, the membrane 440 is a seal used to prevent a pressure exchange between the segregated portions of the body or two segregated segments 200. A membrane 440 may comprise an elastic or a flexible material, such as an elastomer. In some embodiments, the membrane 440 comprises a natural or a biodegradable material. In a number of embodiments, the membrane 440 comprises a polymeric material. In certain embodiments, membrane 440 is interfaced with a valve which controls pressure between two segments separated by the membrane 440. In some embodiments, the membrane 440 comprises, or is interfaced with a pressure adjuster 430.

Pressure adjusters 435, such as 435A and 435B in FIG. 4A may be any devices changing or adjusting the pressure inside the body 100. In some embodiments, pressure adjusters 435 are any components, devices or apparatuses changing the pressure inside the body 100 or inside a segment or a plurality of segments 200 of the body 100. Pressure adjuster may be any device or an apparatus filling the body 100 with air, liquid, gel or any other pressurizing material or component. In some embodiments, pressure adjusters 435 comprise one or more valves 401. In some embodiments, the pressure adjuster 435 comprises any device for moving air, liquid, gel or a filling used for pressurizing the body, such as a pump or a fan. In a number of embodiments, the pressure adjuster 435 comprises a motor. Pressure adjusters 435 may comprise any mechanisms, apparatuses or systems moving air, water, gel or any other filling of the body 100 toward a certain direction or into a certain part of the body 100.

Referring now to FIG. 4B, an embodiment of the soft-bodied robot including a number of electronic components is depicted. FIG. 4B illustrates a body 100 comprising a plurality of concatenated segments 201, 203-N. FIG. 4B further depicts a number of components within the body 100 including: a control unit 500, a memory unit 510, sensors 520A and 520B, a motion controller 530, a power supply 540, a software 550, a receiver 610, a transmitter 620, and a pressure controller 410. In embodiment illustrated in FIG. 4B may be related to a number of other embodiments comprising any or none of components illustrated in FIG. 4B and one or a plurality of other components enclosed within a body.

Control unit 500 may be any controller controlling any movement or any function implemented by the soft-bodied robot. Control unit 500 may be any controller, logic unit, computer, application, component or a device capable of controlling one or more features, functionalities or components of the soft-bodied robot. In some embodiments, the control unit 500 is a component comprising a digital or analog logic circuitry used for monitoring, processing or interpreting any input to the control unit, generating commands, and controlling other components of the soft-bodied robot. In some embodiments, a control unit 500 comprise a microprocessor, a logic unit, a processing unit, a memory, control circuitry and a power supply. In certain embodiments, the control unit 500 comprises circuitry for receiving and transmitting communication between the body 100 of the soft-bodied robot and a device, component or a receiver outside of the body 100. In some embodiments, the control unit 500 monitors or processes inputs from other components, such as sensors, detectors, cameras, valves, controllers, or receivers.

In some embodiments, control unit 500 comprises circuitry for receiving and transmitting wireless communication with receivers away from the soft-bodied robot. In some embodiments, control unit 500 comprises a pressure controlling circuitry. In some embodiments, the control unit 500 comprises a pressure controller 410. In some embodiments, control unit 500 comprises one or more sensors, such as a pressure sensor 430, a light sensor, a sonar sensor, a camera or a microphone. In certain embodiments, control unit 500 comprises a circuitry for receiving and processing information via wireless signal. In a number of embodiments, control unit 500 comprises a control circuitry for sending an information via a transmitter or via a wireless link. In some embodiments, control unit 500 comprises a motion controller, such as a controller for controlling and coordinating the movements of actuators 300 and moving the body 100 or the soft-bodied robot. In a number of embodiments, control unit 500 comprises a battery or a power supply. In some embodiments, control unit 500 comprises software or algorithms for moving and controlling the movement of the soft-bodied robot. The control unit 500 may also comprise software for controlling and processing signals from a camera positioned on, or within, the body 100, a microphone, a motion sensor, a pressure sensor or any other component within the body 100. In some embodiments, control unit 500 comprises a single centralized system, while in other embodiments it is comprised from a plurality of controllers or subcomponents communicating together. The control unit may include functionality for retrieving commands, instructions, functions, applications or software from the memory unit 510. In some embodiments, the control unit implements the commands, instructions, functions, applications and software from the memory unit 510 to coordinate movement of one or more actuators 300 and coordinate movement of the soft-bodied robot.

A memory unit 510 may be any component, device or a unit capable of storing information. Memory unit 510 may comprise one or a plurality of memory devices or segments. In some embodiments, memory unit 510 comprises a volatile memory, such as a RAM, a DRAM, a DDR SDRAM, a SRAM, a Z-RAM or a TTRAM. In a number of embodiments, memory unit 510 comprises a flash memory such as a FeRAM, a MRAM, a PRAM, a SONOS, a RRAM, or a NRAM. In certain embodiments, memory unit 510 comprises a non-volatile memory such as a ROM, a PROM, an EAROM, an EPROM, or an EEPROM. A memory unit 510 may comprise any combination of different types of memory presented above, or a combination of all. In some embodiments, memory unit 510 comprises any type of memory or information storage component, device or a system. In a number of embodiments, memory unit 510 is connected to or associated with another system, controller or a component. In some embodiments, memory unit 510 stores one or more software, algorithms, sequences, executable code, scripts or programs used to control one or more components or functionalities of the soft-bodied robot. In further embodiments, the memory unit 510 comprises one or more components, functions, programs or algorithms of the simulator. In still further embodiments, the memory unit 510 includes instructions, commands or operations for controlling one or more components of the soft-bodied robot and coordinating movement. In yet further embodiments, the memory unit 510 includes instructions to control or coordinate movement of the actuators 300.

Sensors 520A and 520B may be any devices capable of detecting or sensing light, sound, pressure, temperature, humidity, heat, movement or radiation of any kind. In some embodiments, sensor 520 is any type of a sensing or a detecting device, component or a system capable of gathering information by sensing the environment surrounding the soft-bodied robot. In some embodiments, the sensor 520 is a temperature sensor. In a number of embodiments, the sensor 520 is a pressure sensor. In certain embodiments, the sensor 520 is a light sensor. In a number of embodiments, the sensor 520 is a camera or a video recorder. In some embodiments, the sensor 520 is a microphone or a sound recorder. In many embodiments, the sensor 520 is a motion sensor. The sensor 520 may be, a heat sensor or an infrared camera. In certain embodiments, the sensor 520 is a flow sensor measuring the flow of air or water surrounding the soft-bodied robot. In a number of embodiments, the sensor 520 is an electric field or a magnetic field sensor. In some embodiments, sensor 520 is a metal detector. In some embodiments, sensor 520 is a sonar sensor. In a number of embodiments, sensor 520 is a biological agent sensor, such as an anthrax sensor for example. In some embodiments, sensor 520 is a detector for detecting a specific molecule, a virus or a natural element. In some embodiments, sensor 520 is a sensor for detecting a specific gas, specific liquid, or a specific material. In certain embodiments, sensor 520 is a sound detector or a vibrations detector. In some embodiments, sensor 520 is a proximity sensor capable of measuring distances between the soft-bodied robot or the body 100 and an object external to the soft-bodied robot. The sensor may be any component capable of sensing, detecting, recording or otherwise gathering any data outside of the body 100 of the soft-bodied robot.

Sensors 520 may be located anywhere on a surface or inside of the body 100. In the embodiments illustrated by FIG. 4B, the sensor 520A is attached on the surface of the body 100, while the sensor 520B is shown being enclosed within the body 100. In some embodiments, any number of sensors 520 of a same kind or a different kind may be combined into a sensing system used by the soft-bodied robot. In some embodiments, body 100 comprises one or more sensor controllers used for monitoring or controlling a sensor 520 or a plurality of sensors 520. In a number of embodiments, sensor 520 is connected or in a communication with a control unit 500. The sensor 520 may be controlled by the control unit 500 and may return the outputs from the sensor 520 to the control unit 500 for further processing. In some embodiments, sensor 520 comprises logic circuits, such as control circuit to monitor, control, modify, or calibrate itself or other sensors 520 within the body 100.

Motion controller 530 may be any controller managing, monitoring, handling or otherwise being in charge of the actuators 300. In some embodiments, motion controller 530 is any controller controlling movement of the body 100 or the soft-bodied robot. Motion controller 530 may comprise control circuitry necessary to monitor, control and coordinate movement of one or more actuators 300 within the body 100. Motion controller 530 may comprise any number components such as logic circuits, microprocessors, memory units, instruction sets, software and algorithms enabling it to coordinate the movement of the soft-bodied robot. In some embodiments, motion controller 530 comprises a logic unit, such as a control unit or a processing unit. In some embodiments, motion controller 530 comprises a memory unit comprising an instruction set or an executable file for controlling an actuator 300. In some embodiments, motion controller 530 comprises a memory unit comprising a plurality of instruction sets for a variety of motions for all actuators 300 within the body 100. A motion controller 530 may further comprise a power supply and a control circuitry for applying current or voltage to control the movements of the actuators 300. Motion controller 530 may also comprise a plurality of drivers to control the amount of current delivered to each of the actuators, thus providing fine control of each of the actuators 300. Motion controller 530 may comprise any type of devices and components and any type of functionality enabling it to control movement of any one or all of actuators 300 within the soft-bodied robot body 100.

Power supply 540 may be any source of power. In some embodiments, power supply 540 is a battery. In some embodiments, power supply 540 is circuit. Sometimes, the power supply 540 comprises a solar panel for charging a battery stored inside the body 100, and circuitry to enable charging of the battery. In some embodiments, power supply 540 comprises a converter for converting heat into electrical energy. In some embodiments, power supply 540 comprises a converter converting light into electrical energy. In a number of embodiments, power supply 540 comprises a converter converting any source of power of energy into electrical energy. Power supply 540 may comprise any number of any combination of circuitry, batteries and converters to provide energy or power to enable functionality of the soft-bodied robot.

Software 550 may be any software, application, algorithm, script, firmware, executable file, script or a library utilized by any controller in the body 100 to provide functionality to the soft-bodied robot. In some embodiments, software 550 comprises executable files comprising instructions for specifying movement of the soft-bodied robot. In some embodiments, software 550 includes a library of instructions for providing movement of the soft-bodied robot by engaging any number of the actuators 300. In a number of embodiments, the software 550 comprises files, programs, algorithms or applications for managing or operating any kind of sensor 520. In some embodiments, software 550 comprises files, programs, algorithms or applications for operating or managing any kind of controller, such as a control unit 500, motion controller 530 or a pressure controller 410. In some embodiments, software 550 comprises files, instructions, programs or applications for controlling any receivers or transmitters for receiving or transmitting communication to and from the soft-bodied robot.

Receiver 610 is any kind of receiver, interface, device or a port capable of receiving communication from a source inside or outside of the body 100 of the soft-bodied robot. In some embodiments, receiver 610 is a wireless link receiving wireless communication from a source external to the body 100 of a soft-bodied robot. In some embodiments, receiver 610 is a port, such as a connection receiving information via a wire connected to the body 100 of the soft-bodied robot. Receiver 610 may be a radio link or a radio receiver receiving a signal via radio waves. In some embodiments, receiver 610 is an antenna, or a device comprising an antenna which receives a wireless signal of any kind.

Transmitter 620 is any kind of transmitter, interface, port or a device capable of transmitting a signal to a receiver inside or outside of the body 100. In some embodiments, transmitter 620 is a wireless transmitter sending wireless communication to a source external to the body 100. In some embodiments, transmitter 620 is a port, such as a connection transmitting information via a wire connected to the body 100 of the soft-bodied robot. Transmitter 620 may be a radio link or a radio transmitter sending out a signal via radio waves. In some embodiments, transmitter 620 is an antenna or is a device comprising an antenna which transmits a wireless signal of any kind.

Components of the soft-bodied robot may be connected to each other and transmit communication and power to each other via any type and form of a medium. In some embodiments, components communicate with each other via wireless communication. In other embodiments, components communicate with each other via wires or cables. In further embodiments, a power supply 540 provides power to one or more components via any number of cables, connectors, pins, wires or any other type and form of conductor. In still further embodiments, components of the soft-bodied robot communicate with each other or transmit power or electrical signals to each other via conductive inks or conductive adhesives. In further embodiments, components transmit electrical signals or power to each other via carbon or metal doped elastomer materials.

Methods for Controlling and Coordinating Movement of the Soft-Bodied Robots

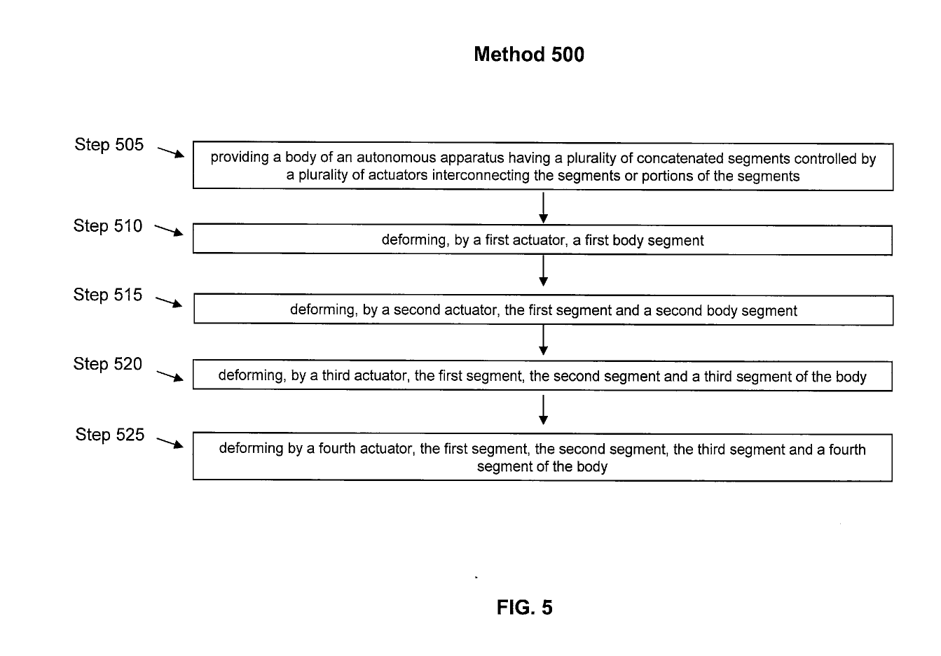

Referring now to FIG. 5, a flow diagram of an embodiment of steps of a method 500 for providing movement to an autonomous platform or an autonomous apparatus, such as a soft-bodied robot, is depicted. In a brief overview of method 500, at step 505 an autonomous platform or an apparatus is provided having a plurality of concatenated segments controlled by a plurality of actuators interconnecting the segments or portions of segments. At step 510, a first actuator deforms a first body segment. At step 515, a second actuator deforms the first segment and a second body segment. At step 520, a third actuator deforms the first segment, the second segment and a third segment of the body. At step 525, a fourth actuator deforms the first segment, the second segment, the third segment and a fourth segment of the body. At step 530, a fifth actuator deforms the first segment, the second segment, the third segment, the fourth segment and the fifth segment of the body.

In further detail, at step 505, an autonomous platform, or an autonomous apparatus, comprises a body having a plurality of concatenated segments controlled by a plurality of actuators which interconnect the segments or portions of the segments of the body. In some embodiments, the autonomous platform, or the autonomous apparatus, is a soft-bodied robot and the body is the body 100. The body of the autonomous apparatus may comprise any number of segments, such as segments 200. The body may further comprise a plurality of concatenated segments controlled by a plurality of actuators, such as actuators 300. The actuators may be enclosed within the body and may comprise two or more ends via which the actuators connect or interconnect different segments of the body or different portions of the same segment of the body. The body of the autonomous apparatus may comprise actuators positioned within the body, interconnecting different segments of the body and being positioned such to enable deformation or morphing of the body upon the movement of the actuators.

At step 510, the first actuator contracts, extends, shrinks, expands, bends, straightens twists, untwists or otherwise deforms a first body segment. The first actuator may deform contract or extend a first body segment or cause contraction or extension of the first body segment. In some embodiments, the first actuator contracts or extends and in response to the contraction or extension of the first actuator, the first body segment connected to the first actuator deforms by contracting or extending. Sometimes, the first actuator may shrink or expand the first body segment. In some embodiments, the first actuator shrinks or expands, and in response to shrinkage or expansion of the first actuator, the first body segment connected to the first actuator, deforms by shrinking or expanding. The first actuator may bend or straighten the first body segment. In many embodiments, the first actuator bends or straightens, and in response to the bending or straightening of the first actuator, the first body segment connected to the first actuator deforms by bending or straightening. Sometimes, the first actuator may twist or untwist the first body segment. In many embodiments, the first actuator twists or untwists, and in response to the twisting or untwisting of the first actuator, the first body segment connected to the first actuator, deforms by twisting or untwisting. In many embodiments, the first actuator morphs or reshapes the first body segment. In a number of embodiments, the first actuator changes the volume of the first body segment. In a variety of embodiments, the first actuator deforms or moves, and in response to the movement or deforming of the first actuator, the first body segment moves or deforms.

At step 515, a second actuator contracts, extends, shrinks, expands, bends, straightens twists, untwists or otherwise deforms the first body segment and a second body segment. The second actuator may contract or extend the first body segment and a second body segment or cause contraction or extension of the first body segment and the second body segment. In some embodiments, the second actuator contracts or extends and in response to the contraction or extension of the second actuator, the first body segment and the second body segment, which are connected to the first actuator, deform by contracting or extending. Sometimes, the second actuator may shrink or expand the first body segment and the second body segment. In some embodiments, the second actuator shrinks or expands, and in response to shrinkage or expansion of the second actuator, the first and the second body segments, which are connected to the second actuator, deform by shrinking or expanding. The second actuator may bend or straighten the first and second body segments. In many embodiments, the second actuator bends or straightens, and in response to the bending or straightening of the second actuator, the first and second body segments connected to the second actuator deform by bending or straightening. Sometimes, the second actuator may twist or untwist the first and second body segments. In many embodiments, the second actuator twists or untwists, and in response to the twisting or untwisting of the second actuator, the first and second body segments, which are connected to the first actuator, deform by twisting or untwisting. In many embodiments, the second actuator morphs or reshapes the first and second body segments. In a number of embodiments, the second actuator changes the volume of the first and second body segments. In a variety of embodiments, the second actuator deforms or moves, and in response to the movement or deforming of the second actuator, the first and second body segments move or deform.

At step 520, a third actuator contracts, extends, shrinks, expands, bends, straightens twists, untwists or otherwise deforms the first body segment, the second body segment and a third body segment. The third actuator may contract or extend the first, second and third body segments or cause contraction or extension of the first, second and third body segments. In some embodiments, the third actuator contracts or extends and in response to the contraction or extension of the third actuator, the first, second and third body segments, being at least in part interconnected by the third actuator, deform by contracting or extending. Sometimes, the third second actuator may shrink or expand the first, second and third body segments. In some embodiments, the third actuator shrinks or expands and in response to the shrinkage or expansion of the third actuator, the first, second and third body segments, being at least in part interconnected by the third actuator, deform by shrinking or expanding. The third actuator may bend or straighten the first, second and third body segments. In many embodiments, the third actuator bends or straightens, and in response to the bending or straightening of the third actuator, the first, second and third body segments, being at least in part interconnected by the third actuator, deform by bending or straightening. Sometimes, the third actuator may twist or untwist the first, second and third body segments. In many embodiments, the third actuator twists or untwists, and in response to the twisting or untwisting of the third actuator, the first, second and third body segments, being at least in part interconnected by the third actuator, deform by twisting or untwisting. In many embodiments, the third actuator morphs or reshapes the first, second and third body segments. In a number of embodiments, the third actuator changes the volume of the first, second and third body segments. In a variety of embodiments, the third actuator deforms or moves, and in response to the movement or deforming of the third actuator, the first, second and third body segments move or deform.

At step 525, a fourth actuator contracts, extends, shrinks, expands, bends, straightens twists, untwists or otherwise deforms the first body segment, the second body segment and a third body segment. The fourth actuator may contract or extend the first, second, third and the fourth body segments or cause contraction or extension of the first, second, third and fourth body segments. In some embodiments, the fourth actuator contracts or extends and in response to the contraction or extension of the fourth actuator, the first, second, third and fourth body segments, being at least in part interconnected by the fourth actuator, deform by contracting or extending. Sometimes, the fourth second actuator may shrink or expand the first, second, third and fourth body segments. In some embodiments, the fourth actuator shrinks or expands and in response to the shrinkage or expansion of the fourth actuator, the first, second, third and fourth body segments, being at least in part interconnected by the fourth actuator, deform by shrinking or expanding. The fourth actuator may bend or straighten the first, second, third and fourth body segments. In many embodiments, the fourth actuator bends or straightens, and in response to the bending or straightening of the fourth actuator, the first, second, third and fourth body segments, being at least in part interconnected by the fourth actuator, deform by bending or straightening. Sometimes, the fourth actuator may twist or untwist the first, second, third and fourth body segments. In many embodiments, the fourth actuator twists or untwists, and in response to the twisting or untwisting of the fourth actuator, the first, second, third and fourth body segments, being at least in part interconnected by the fourth actuator, deform by twisting or untwisting. In many embodiments, the fourth actuator morphs or reshapes the first, second, third and fourth body segments. In a number of embodiments, the fourth actuator changes the volume of the first, second, third and fourth body segments. In a variety of embodiments, the fourth actuator deforms or moves, and in response to the movement or deforming of the fourth actuator, the first, second, third and fourth body segments move or deform.

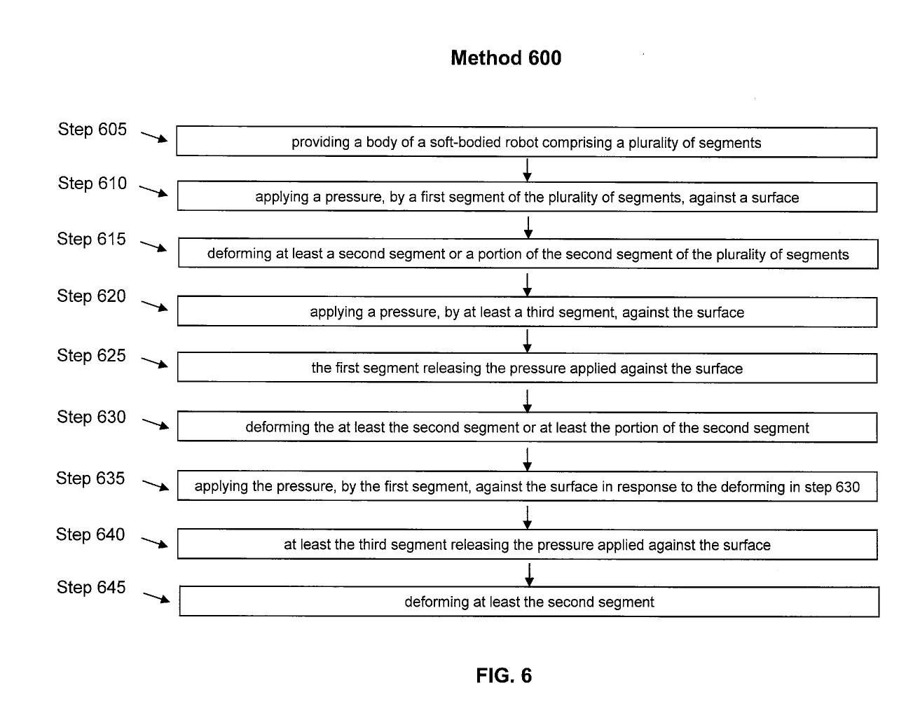

Referring now to FIG. 6, a flow diagram of an embodiment of steps of a method 600 for creating movement of an autonomous apparatus is depicted. In a brief overview of method 600, at step 605 a body of a soft-bodied robot is provided comprising a plurality of segments. At step 610, a first segment of the plurality of segment applies pressure against a surface. At step 615, at least a second segment, or at least a portion of the second segment of the plurality of segments deforms. At step 620, at least a third segment applies a pressure against the surface. At step 625, the first segment releases the pressure applied against the surface. At step 630, the at least the second segment or at least the portion of the second segment deforms. At step 635, the first segment applies the pressure against the surface in response to deforming at step 630. At step 640, the at least the third segment releases the pressure applied against the surface. At step 645, at least the second segment deforms.

In further detail, at step 605 a body of a soft-bodied robot comprising a plurality of segments is provided. In some embodiments, the body comprises a plurality of concatenated segments, wherein each of the segments connects to no more than two other segments of the body. In various embodiments, the body of the soft-bodied robot comprises a plurality of actuators, such as actuators 300. The body may be a caterpillar shaped soft-bodied robot comprising any number of components and actuators within the body for controlling the movement of the body.

At step 610, a body of a soft-bodied robot applies a pressure by a first segment of the plurality of segments of the body against the surface over which the soft-bodied robot moves. In some embodiments, one or more actuators of the body deform or move the first segment or a portion of the first segment to cause the first segment to apply pressure against the surface. Sometimes, a plurality of segments including the first segment apply pressure against the surface. In a number of embodiments, the first segment comprises a leg which is moved by the body, or any component within the body, to apply the pressure against the surface over which the soft-bodied robot moves. Sometimes, the first segment comprises a sharp tip, a hook or a crochet which presses against the surface. In a number of embodiments, the soft-bodied robot utilizing actuators within the body maneuvers or coordinates movement of segments surrounding the first body segment in order to press the first body segment against the surface.

At step 615, the body shrinks, contracts, twists, bends or otherwise deforms at least a second segment of the plurality of segments of the body or a portion of the second segment. In some embodiments, at least the second segment is contracted or shrunk by one or more actuators within the second segment or within the segments surrounding the second segment. In some embodiments, at least the second segment is twisted or bent by one or more actuators within the second segment or within the segments surrounding the second segment. In various embodiments, at least the second segment corresponds to a plurality of segments contracted, shrunk, twisted or otherwise deformed by the soft-bodied robot. Sometimes, the at least the second segment corresponds to a plurality of segments wherein one of the plurality is the second segment. The at least second segment may contract, become smaller or deform in any way to make the at least second segment smaller or shorter. In various embodiments, a portion of the second segment is contracted, shrunk, twisted or bent by the soft-bodied robot. In many embodiments, at least the second segment is morphed or deformed by the soft-bodied robot in a way wherein the total volume of the at least the second segment is decreased. In some embodiments, at least the second segment is morphed or deformed by the soft-bodied robot in a way wherein the total volume of the at least the second segment, or the length of the at least the second segment, is decreased.

At step 620, the body applies pressure against the surface via at least a third segment of the plurality of segments. In some embodiments, the body applies the pressure against the surface via a portion of the third segment. Sometimes, the body may apply the pressure against the surface via a portion of the second segment. In a number of embodiments, a plurality of segments including the third segment apply the pressure against the surface. In some embodiments, a plurality of segments including the second segment apply the pressure against the surface. In some embodiments, one or more actuators within the soft-bodied robot move at least the third segment or a portion of the third segment causing it to apply pressure against the surface. At least the third segment, in some instances, may correspond to a plurality of segments which may include the third segment which apply the pressure against the surface. In some embodiments, at least the third segment corresponds to a section of the body which may include any number of segments, applying the pressure or pressing against the surface. In a number of embodiments, at least the third segment comprises at least one leg which is moved by the soft-bodied robot to apply the pressure against the surface over which the soft-bodied robot moves. Sometimes, at least the third segment comprises a sharp tip, a hook or a crochet which presses against the surface. In a number of embodiments, the soft-bodied robot utilizing actuators within the body maneuvers or coordinates movement of segments surrounding the third segment in order to press at least the third segment against the surface. The body may apply pressure against the surface via at least the third segment by using the at least the third segment to touch, interface with or press against the surface while other segments of the body do not touch, interface with or press against the surface.

At step 625 the body releases the pressure applied by the first segment against the surface. In some embodiments, the plurality of segments including the first segment release the pressure applied by the plurality of segments including the first segment against the surface. In some embodiments, the first segment comprising a leg releases the pressure previously applied by the leg of the first segment against the surface. In a number of embodiments, a plurality of actuators controlling the first segment deform the first segment to release the pressure applied by the first segment against the surface. In many embodiments, the plurality of actuators controlling a plurality of segments including the first segment deform the plurality of segments to release the pressure applied by the plurality against the surface. In some embodiments, the first segment releases the pressure applied against the surface such that the first segment does not touch or interfaces with the surface following the release of the pressure by the first segment. In many embodiments, the plurality of segments including the first segment release the pressure applied to the surface by the plurality by deforming such that the plurality of segments including the first segment do not touch or interface with the surface following the release of the pressure.

At step 630, the body or any component of the body extends, stretches, expands, straightens, untwists or otherwise deforms at least the second segment or at least a portion of the second segment deforms. In some embodiments, at least the second segment is extended, stretched, expanded by one or more actuators within the second segment or within the segments surrounding the second segment. In some embodiments, the second segment is straightened or untwisted by one or more actuators within the second segment or within the segments surrounding the second segment. Sometimes, the extending, stretching, expanding, straightening, untwisting of at least the second segment is implemented by the body after the body has previously shrunk, contracted, twisted, bent or deformed in any way to decrease the length or volume of the at least the second segment. In various embodiments, at least the second segment corresponds to a plurality of segments which were previously contracted, shrunk, twisted or otherwise deformed by the soft-bodied robot such that they have decreased in size. Sometimes, the at least the second segment corresponds to a plurality of segments wherein one of the plurality is the second segment. The at least second segment may extend, expand, stretch or otherwise deform to in any way to make the at least second segment larger or longer. In various embodiments, a portion of the second segment is extended, stretched, expanded, untwisted or straightened or otherwise deformed by the soft-bodied robot in response to a previously implemented step of shrinking, contracting, twisting, bending of the at least the second segment. In some embodiments, a portion of the second segment is extended, stretched, expanded, untwisted or straightened or otherwise deformed by the soft-bodied robot in response to releasing the pressure applied by the first segment. In some embodiments, a portion of the second segment is extended, stretched, expanded, untwisted or straightened or otherwise deformed by the soft-bodied robot in response to releasing the pressure applied by the third segment. In many embodiments, at least the second segment is morphed or deformed by the soft-bodied robot in a way wherein the total volume of the at least the second segment is increased. In some embodiments, at least the second segment is morphed or deformed by the soft-bodied robot in a way wherein the total volume of the at least the second segment is increased.

At step 635, the body applies the pressure via the first segment against the surface in response to the body extending, stretching, expanding, straightening, untwisting or otherwise deforming at least the second segment or at least a portion of the second segment in step 630. In some embodiments, the body applies pressure by the first segment or the plurality of segments including the first segment against the surface in response to the deforming in step 630. In some embodiments, one or more actuators of the body deform or move the first segment or a portion of the first segment to cause the first segment to apply pressure against the surface. The body may apply the pressure against the surface via the first segment in response to the deforming by the body in step 630 and in response to the body applying the pressure against the surface via the third segment in step 620. In a number of embodiments, a leg of the first segment is moved by the body to apply the pressure against the surface over which the soft-bodied robot moves in response to deforming of the at least the second segment of the body. In some embodiments, a sharp tip, a hook or a crochet of the first segment applies pressure against the surface in response to the deforming in step 630.

At step 640, the body releases the pressure applied against the surface via at least the third segment. In some embodiments, the body releases the pressure applied against the surface via at least the third segment by coordinating actuators within the third segment to deform the third segment and release the pressure. In many embodiments, the body releases the pressure applied against the surface via the plurality of segments including the third segment by coordinating actuators surrounding the plurality of segments including the third segment to deform the plurality of segments including the third segment and release the pressure applied by the plurality of segments including the third segment against the surface. In some embodiments, the body releases the pressure applied against the surface via at least the third segment in response to body applying the pressure in step 635. In many embodiments, the body releases the pressure applied against the surface via at least the third segment in response to the body deforming in step 630.

At step 645, the body shrinks, contracts, twists, bends or otherwise deforms at least a second segment of the plurality of segments of the body or a portion of the second segment. In some embodiments, at least the second segment is contracted or shrunk by one or more actuators within the second segment or within the segments surrounding the second segment. In some embodiments, at least the second segment is twisted or bent by one or more actuators within the second segment or within the segments surrounding the second segment. In various embodiments, at least the second segment corresponds to a plurality of segments contracted, shrunk, twisted or otherwise deformed by the soft-bodied robot. In many embodiments, at least the second segment is morphed or deformed by the soft-bodied robot in a way wherein the total volume of the at least the second segment is decreased. In some embodiments, at least the second segment is morphed or deformed by the soft-bodied robot in a way wherein the total volume of the at least the second segment, or the length of the at least the second segment, is decreased. In some embodiments, the body shrinks, contracts, twists, bends or otherwise deforms at least the second segment to make at least the second segment smaller or shorter in response to the body releasing the pressure in step 640. In a number of embodiments, the body shrinks, contracts, twists, bends or otherwise deforms at least the second segment to make at least the second segment smaller or shorter in response to the body applying the pressure in step 635.

1. A soft-bodied autonomous platform comprising:
a body comprising a first segment, a second segment connected with the first, and a third segment connected with the second but not the first;
a first actuator attached to an interior of the first segment and an interior of the second segment, the first actuator enclosed within the body;
a second actuator attached to the interior of the first segment and to an interior of the third segment, the second actuator enclosed within the body.

2. The apparatus of claim 1, wherein the first actuator deforms the first segment and the second segment and wherein the second actuator deforms the first segment, the second segment and the third segment.

3. (canceled)

4. The apparatus of claim 1, further comprising a third actuator attached to the interior of the second segment and the interior of the third segment, the third actuator enclosed within the body, the third actuator deforming the second and the third segments.

5. The apparatus of claim 1, further comprising a fourth segment connected with the third segment, but not connected with the first segment and the second segment, and a third actuator having a first and a second end, the first end of the third actuator attached to the interior of the first segment and the second end of the third actuator attached to an interior of the fourth segment, the third actuator enclosed within the body and deforming the first, the second, the third and the fourth segments.

6-8. (canceled)

9. The apparatus of claim 1, wherein any one of the first actuator or the second actuator comprises one of a shaped memory alloy or an elastomeric material.

10. (canceled)

11. The apparatus of claim 1, wherein any one of the first actuator or the second actuator comprises one of an elastomeric material or an electroactive polymer.

12-14. (canceled)

15. The apparatus of claim 1, wherein the actuators deform a portion of the body by producing one of a bending, crawling, cantilevering, contractin extending or twisting movement of the portion of the body.

16-18. (canceled)

19. The apparatus of claim 1, wherein the shape of the body is substantially similar to a shape of a caterpillar, the body comprising a set of legs, each one of the set of legs comprising a bump protruding from a bottom portion of the body, the body further comprising any one of a sensor, a detector, a transmitter or a receiver.

20-44. (canceled)

45. A method for creating a movement of an autonomous apparatus, wherein a polymeric body having at least three concatenated segments having a second segment connected with a first segment and a third segment wherein the third segment is not connected with the first segment, and a first actuator having two ends, both ends connecting to an interior of the first segment, a second actuator attached to the interior of the first segment and an interior of the second segment, and a third actuator attached to the interior of the first segment and an interior of the third segment, the first actuator and the second actuator and the third actuator enclosed within the body, the method comprising:
deforming, by a first actuator a first body segment and a second body segment; and
deforming, by a second actuator the first segment, the second segment, and a third body segment.

46. The method of claim 45, further comprising deforming, by a third actuator, a first segment, and deforming the first segment, the second segment, the third segment and a fourth segment, by a fourth actuator enclosed within the body, the fourth actuator attached to the area inside of the first segment and an area inside of the fourth segment, the fourth segment connected to the third segment, but not connected to the first segment and the second segment.

47. (canceled)

48. The method of claim 45, further comprising collapsing, by an actuator, any one of the first segment, the second segment or the third segment to a fraction of a maximum volume of that segment.

49-50. (canceled)

51. The method of claim 45, further comprising contracting, by an actuator, any one of the first segment, the second segment or the third segment.

52. The method of claim 45, further comprising extending, by an actuator, any one of the first segment, the second segment or the third segment.

53-59. (canceled)

60. A method for creating a movement of an autonomous apparatus by deformation of a body of the autonomous apparatus, the method comprising:
a) providing, by an autonomous apparatus, a body comprising a plurality of segments;
b) pressing, by a first segment of the plurality, against a surface;
c) deforming, by the body, at least a second segment of the plurality;
d) pressing, by a third segment of the plurality, against the surface;
e) releasing, by the first segment, pressure of the first segment against the surface;
f) deforming, by the body, at least the second segment;
g) pressing, by the first segment, against the surface in response to the expanding in step f);
h) releasing, by the third segment, pressure of the third segment against the surface;
i) contracting, by the body, at least the second segment in response pressing in step g).

61. The method of claim 60, wherein step c) further comprises deforming, by the body, a second plurality of segments; by contracting the second plurality of segments, and step f) further comprises deforming, by the body, the second plurality of segments by expanding the second plurality of segments.

62. The method of claim 60, wherein step c) further comprises deforming, by the body, a second plurality of segments by bending the second plurality of segments, and step f) further comprises deforming, by the body, the second plurality of segments by extending the second plurality of segments.

63. The method of claim 60, wherein step c) further comprises deforming, by the body, at least the second segment by contracting at least the second segment.

64. The method of claim 63, wherein step c) further comprises deforming, by the body, at least the second segment by contracting the at least second segment in response to step b).

65. The method of claim 60, wherein step c) further comprises deforming, by the body, at least the second segment by bending the at least second segment.

66. (canceled)

67. The method of claim 60, wherein step e) further comprises releasing, by the first segment, pressure of the first segment against the surface in response to the step d).

68-69. (canceled)
